(19) United States
(12) Patent Application Publication
(10) Pub. No.: US 2024/0157923 A1
(43) Pub. Date: May 16, 2024

(54) FAIL-SAFE BRAKING SYSTEM

(71) Applicant: Heinz LEIBER, Oberriexingen (DE)

(72) Inventor: Heinz LEIBER, Oberriexingen (DE)

(21) Appl. No.: 18/285,998

(22) PCT Filed: Apr. 6, 2022
(86) PCT No.: PCT/EP2022/059069

§ 371 Date: Oct. 6, 2023

(30) Foreign Application Priority Data
Apr. 7, 2021 (DE) 20 2021 105 880.3
Sep. 9, 2021 (DE) 20 2021 105 878.1
Jan. 28, 2022 (DE) 10 2022 102 036.3

(51) Int. Cl. B60T 13/68; B60T 8/171; B60T 13/14; B60T 13/62; B60T 17/22

(52) U.S. Cl. CPC B60T 13/686; B60T 8/171; B60T 13/142; B60T 13/148; B60T 13/62; B60T 17/22; B60T 2220/04; B60T 2270/402; B60T 2270/404; B60T 2270/413; B60T 2270/82

(57) ABSTRACT

A brake system may have at least two wheel brake cylinders that are parts of respective wheel circuits, a pressure supply arranged to build up pressure in the wheel brake cylinders, an electronic control and regulation device, and switching valves connecting respective wheel brake cylinders, via respective hydraulic lines, to a further hydraulic main line. The further hydraulic main line may connect the wheel brake cylinders to the pressure supply. Redundancy may be built into the switching valves.

### CROSS-REFERENCE TO RELATED APPLICATION

This application is a Section 371 of International Application No. PCT/EP2022/059069, filed Apr. 6, 2022, which was published in the German language on Oct. 13, 2022 under International Publication No. WO 2022/214521 A1, which claims priority under 35 U.S.C. § 119(b) to German Patent Application No. 20 2021 105 880.3, filed Apr. 7, 2021, German Patent Application No. 20 2021 105 878.1, filed Sep. 9, 2021, and German Patent Application No. 10 2022 102 036.3, filed Jan. 28, 2022, the disclosures of which are incorporated herein by reference.

### STATE OF THE ART

For almost 80 years, today's 2-circuit braking system with two brake circuits has become established for safety reasons and, depending on the vehicle design, is used in a brake circuit layout of
a) diagonal and
b) black/white or front axle/rear axle
   applied. In the event of a brake circuit failure, the braking effect is reduced by 50% for a) and even by up to approximately 70% for b). In the statistics, 10 ppm/J is calculated for a brake circuit failure. Due to the reduced braking effect or total brake failure, there is a considerable risk of accidents.

DE 10 20 2018 213 306 describes a system with detection of brake circuit failure due to leakage of the brake circuit by evaluating the pressure gradient.

Almost all vehicles have electronic brake control systems for all four vehicle wheels, which are usually braked hydraulically. Each wheel brake cylinder is connected to at least one or two electromagnetically controlled control valves, which are electrically controlled by an electrical control unit (ECU), e.g. to prevent the wheel from locking.

In today's standard brake systems with ABS/ESP function, an inlet and an outlet valve are usually assigned to each wheel brake cylinder, with the inlet valve usually having a check valve connected in parallel so that the inlet valve, which is often also referred to as the shift valve, does not close due to the back pressure during rapid pressure reduction.

If an inlet valve with its associated check valve fails and leaks, in today's dual-circuit brake systems an entire brake circuit usually fails when the wheel brake cylinder fails, so that the braking effect is reduced by at least 30%.

### OBJECT OF THE INVENTION

The task of the invention is to provide a very fail-safe braking system that requires as few valves as possible.

### Solution of the set object

This task is advantageously solved with a braking system having the features of claim 1. Further advantageous embodiments of this braking system result from the features of the subclaims.

### Advantages of the Invention

The invention is characterized by the fact that components that are as fail-safe as possible are used and/or appropriate safety valves, in particular in the form of separating valves, are provided between the pressure supply and the wheel brake cylinders and/or between wheel circuits or brake circuits.

A common inlet valve used for ABS/ESP has a parallel check valve, which is considered unsafe in tightness, therefore can no longer be used. As described above, the check valve was provided to prevent the inlet valve from closing due to back pressure during rapid pressure reduction.

It is therefore advantageous to use a switching valve instead of an inlet valve with a parallel check valve, which is designed to be tamper-proof at least in one flow direction even at high flow velocities or high pressure gradients.

The switching valve assigned to each wheel brake cylinder should also be designed to be as fail-safe as possible, so that in principle no further valves, in particular isolating valves, are required to isolate a wheel circuit or brake circuit that has become leaky. If safety should nevertheless be increased, at least one of the isolating valves described above can be provided in addition.

To increase fail-safety and braking efficiency in the event of a fault, switching valves for the wheel brake cylinders can also be advantageously used in which the electromagnetic drive or at least some of its components are provided or designed redundantly, i.e. at least twice. For example, the switching valve can have at least two coils and two coil actuators which can switch the switching valve separately from one another, so that if one coil or its actuator fails, the other can take over its function, so that the switching valve is significantly more fail-safe and thus the entire braking system is also advantageously more failsafe.

The coils can also be designed in such a way that they each alone switch the valve reliably up to a certain pressure of e.g. 100 bar and that higher pressures can only be switched by the joint energization or activation of both coils.

The valve according to the invention is understood to mean the valve assigned to each wheel brake cylinder, via which hydraulic medium flows to build up pressure in only this wheel brake cylinder. The term wheel circuit is used here to mean the wheel brake cylinder including the hydraulic connection from the valve to the wheel brake cylinder. Of course, the hydraulic medium can also flow from the associated wheel brake cylinder through valve SV2k back into brake circuit BK1 or BK2 for pressure reduction. An exhaust valve assigned to a wheel brake cylinder is also part of the respective wheel circuit.

For the braking system according to the invention, in order to avoid the problems described above, a switching valve of the “normally de-energized open” type can be used, the valve actuator of which is adjusted by means of a first electromagnetic drive from the open valve position to the closed valve position, in which the valve actuator is pressed against a valve seat. When the electromagnetic drive is not energized or not energized sufficiently, a valve spring presses the valve actuator into the initial position, i.e. into the open valve position. In an advantageous further development of the switching valve described above, it has an additional force-applying device that generates an additional force on the valve actuator, which is directed in the direction of the open valve position and thus supports or replaces the valve spring, resulting in an increased resultant force with which the valve actuator is force-loaded into the open valve position.

The additional force device can be switchable, e.g. formed by an additional electromagnet to the actual valve actuator. It can thus also be described as an active additional force device, since the additional force generated on the valve actuator can be switched on or off as desired and depending on the state of the braking system. However, it is equally possible for the additional force device to act passively, for example by using a permanent magnet. It is also in the spirit of the invention if the force-applying device has an electromagnet as well as a permanent magnet. In all of the above-described embodiments, a force supporting the valve spring is advantageously exerted on the valve actuator by means of the additional force device in order to hold the valve actuator in its open position so that the valve does not close unintentionally.

In the case of a merely active additional force device, the actuator of the switching valve thus only has to act against the force of the valve spring, which can be dimensioned smaller due to the switchable additional force device, so that the switching valve closes reliably and tightness is ensured by a high pressure force.

In the case of a purely passive additional force device, the actual actuator of the switching valve only has to apply an increased force at the start of the stroke movement from the open to the closed position in order to overcome the passive and thus permanently acting additional force. As the air gap becomes increasingly larger, the force of the passive additional force device will quickly decrease and have less of an effect in the closed position of the valve.

This is because the switching valve is the safety gate for the brake circuits BK to the wheel brake cylinder RZ. If one of the four hydraulic connections from the hydraulic control unit to a wheel brake cylinder fails in the brake system according to the invention, or if there is a leak in the wheel brake cylinder, the switching valve according to the invention can disconnect the faulty hydraulic connection or the faulty wheel brake cylinder from the rest of the brake system with a high degree of safety.

The additional force device only needs to be switched on or act when a rapid reduction in pressure is required. In all other operating states of the braking system, the additional holding or supporting force of the power boosting device is not required, so that energy can be saved to advantage. Thus, in the braking system according to the invention, in the event of failure of one wheel circuit, only the braking effect of this one failed wheel circuit is lost, while the braking effect of the remaining three wheel circuits continues to be available. This means that the braking effect is only reduced from four to three intact wheel circuits, so that in the event of the failure of one wheel circuit on the front axle, there is only a loss of braking effect of approx. 35%, as opposed to 70%, as described above for a black/white brake circuit distribution, if one entire brake circuit and therefore two wheel circuits always fail.

The possible embodiments of the switching valve described above may, but need not, be used in the braking system according to the invention.

It is therefore quite possible that only the isolating valves described need to be used in braking systems.

The braking system according to the invention generally has four wheel circuits, in which either two wheel circuits are assigned to each braking circuit or three wheel circuits are assigned to a first braking circuit and a fourth wheel circuit forms a separate braking circuit. If one wheel circuit fails, the three remaining wheel circuits are advantageously still available for the braking effect.

The functional reliability of the brake system according to the invention can be additionally increased in the case of dirt particles in the brake fluid by installing at least one filter with a small mesh size at the inlet and/or outlet of the valve. The mesh size should be selected so small that these small dirt particles generate only small leaks and thus only small flow rates when the switching valve is closed, which can be compensated by the pressure supply, but which can be detected by the diagnostics both via the delivery rate of the pressure supply and via the level in the reservoir.

In order to check the function of the switching valve according to the invention, for example, a measurement of the volume absorption and the time curve of the pressure in the respective wheel circuit and a comparison with the previously determined pressure-volume characteristic curve of the wheel circuit can be carried out during diagnosis. The diagnosis can be carried out during each braking operation and/or also at standstill or during servicing.

The preferred switching valve, as described above, does not require a check valve, but still meets a wide range of requirements. For example, it must remain reliably open in both directions even at high flow rates, i.e. the weak point typical of today's valves, i.e. that a force acts on the valve plug and valve spring at high flow rates due to effects on the valve seat and the valve closes automatically, must not occur.

Advantageously, the shift valve can be optimized by appropriate design of the sealing cone, the dimensions of the return spring and the valve tappet, in addition to the force-applying device. In the closed position of the valve, which can also be called an inlet valve but via which the pressure in the wheel brake cylinder can also be relieved, the press-on force should be significantly smaller than when a progressive spring is used, which has a higher force in this position than in the open position, which is unfavorable for the dimensioning of the solenoid circuit due to correspondingly higher force requirements.

The braking system according to the invention can have different valve circuits:
a) Four switching valves for four wheel brake cylinders each, via which both the pressure build-up and the pressure reduction for the respectively assigned wheel brake cylinders take place;
b) four switching valves for four wheel brake cylinders each and two exhaust valves;
c) four switching valves and four exhaust valves.

When using an outlet valve for a wheel circuit, it is possible to control the pressure buildup Pauf and pressure reduction Pab individually for each wheel. If a leak occurs in a wheel circuit, a diagnostic circuit can advantageously identify the faulty wheel circuit both during braking and parking and close the switching valve belonging to the wheel circuit, so that in the case of this single fault three wheel circuits continue to be available and in the case of a double fault, i.e. if two wheel circuits fail at the same time, two wheel circuits are available in the “worst case”. With conventional braking systems, on the other hand, a total failure of the brake follows in the “worst case”.

In summary, it can be said that a high safety gain can be achieved by making minor changes to the inlet valve and eliminating the check valve with the switching valve. If the switching valve is designed accordingly, a cost reduction is possible in addition to the safety gain.

The braking system according to the invention can also be designed in such a way that instead of four hydraulic wheel circuits, a mixed hydraulic-electric braking system is provided with, for example, hydraulic lines to the hydraulically operating front-wheel brakes and only electrical connections to the electromotively operating brakes (EMB) on the rear axle, the design of which is known. Here, too, the same advantages result if the hydraulic wheel circuits are designed in accordance with the designs described above.

With the additional use of a circuit isolating valve between the two brake circuits or additional circuit isolating valves between the brake circuit and the pressure supply, even in the event of failure of a wheel circuit, this can be isolated via the circuit isolating valve so that the remaining wheel circuit of the respective brake circuit is still effective. Thus, double fault safety is achieved with a vehicle deceleration of 0.65 g.

In addition to the valve concepts described, different pressure supply concepts are also possible, e.g. a single pressure supply for level 2 of automated driving or two pressure supplies for level 3 to level 5 of automated driving, whereby the second, redundant, pressure supply can contain a piston pump or a rotary pump. The rotary pumps have a significant cost advantage. With the piston pump, a simple check valve can be used at the outlet of the pressure supply instead of the solenoid valve, which has the same advantages in the event of a pressure supply failure and is less expensive. In this braking system, pressure reduction during normal braking can be accomplished by controlling the exhaust valves using the pressure transducer signal from the pressure transducer, rather than by controlling the piston of the pressure supply. Since at least two exhaust valves are used, redundant pressure reduction is also provided. Depending on the requirement of the pressure reduction speed and on the number of outlet valves, one, two or more outlet valves can be opened.

Solenoid valves can be provided to isolate the pressure supply from the brake circuits. However, it is also possible to dispense with such isolation valves if the pressure supply is provided with a drive with redundant winding circuitry, e.g. 2×3 phases and/or redundant control, such that no further valves are provided between the switching valves assigned to the wheel circuits and the pressure supply. To prevent a failure of the braking system, e.g. due to a leaky piston seal or small piston clearance, compensation is provided by subsequent delivery.

Advantageously, the usual vehicle tuning in various areas such as logistics, service and homologation can be omitted for the brake systems described above.

The braking system according to the invention thus has four wheel circuits that are controlled individually. As described above, two wheel circuits can be assigned to each brake circuit. Other allocations to the brake circuits, as described above, are also possible.

However, the 4-wheel circuit braking system can also be controlled by the control system as a 2-circuit braking system. Thus, the 4-wheel circuit braking system can be combined with 2-circuit braking systems with four hydraulically braked wheels and thus even achieves double fault safety, by which is meant that even a leakage of a wheel brake cylinder and the failure of the control of the associated switching valve does not lead to a total failure of the braking system, whereby this double fault occurs with the low failure probability of approx. 10⁻¹⁹/J, which is still significantly better than core force safety. Even with this double failure, the braking system according to the invention would still achieve a braking effect of a conventional 2-circuit braking system.

This means that the braking system can be described as failsafe and fail-safe.

Advantageously, a diagnosis of the respective leakage of the individual wheel circuits is carried out at intervals or permanently, whereby depending on the diagnosis result the electronic control and regulating device of the braking system decides whether a wheel circuit is switched off by permanently closing the associated switching valve or continues to be operated for the generation of a braking effect. When the system continues to operate, the leakage detected is used to calculate and carry out an appropriate additional supply or replenishment of brake fluid so that the required braking effect of the respective wheel brake cylinder is achieved.

In order to move from the known braking systems to the braking system according to the invention, it is only necessary to replace the known inlet valves with check valves by the modified switching valve, whereby almost no additional costs are incurred.

The switching valve has another potential, which is used in the event of failure of the exhaust valve assigned to the respective wheel circuit. If, for example, the control of the exhaust valve fails, ABS pressure reduction via the exhaust valve is no longer possible, i.e. the corresponding wheel locks with a loss of braking distance and lateral stability. However, since the shift valve can be used in both directions for pressure buildup and depressurization, as it is resistant to tightening, it can also be used for depressurization if, for example, the pressure supply can absorb the necessary volume for depressurization. Since the switching valves do not contain a check valve, the pressure reduction in one wheel brake cylinder, e.g. RZ1 via the SV2k1, does not simultaneously reduce the pressure in the other wheel brake cylinders, e.g. wheel brake cylinders RZ2, RZ3 and RZ4 when the valves SV2k2, SV2k3, SV2k4 are closed. Advantageously, this can be realized with volume control of the piston of the pressure supply or also a rotary pump, as described in earlier patent applications. For the ABS control, there is only a small disadvantage due to a small time delay of the pump for volume pickup for pressure release, likewise for volume supply for pressure buildup. This is extremely rare, however, as it only occurs when the exhaust valve fails. However, the locking of a wheel during the ABS function must be avoided at all costs, especially in braking systems for automated driving at level >3.

Thus, the switching valve has multiple functions in the safety-related braking system according to the invention:
1. Improved braking effect in the event of failure of a wheel brake cylinder or wheel circuit
2. Maintaining the pressure reduction control function with ABS in the event of failure Opening of the exhaust valve
3. Saving of additional isolating valves to prevent the circuit failure.

For these fault cases, it is appropriate to design the switching valve with redundant coils with connection, since the coil with electrical connection is the failure center.

### FIGURE DESCRIPTION

Various possible embodiments of the braking system according to the invention and the valves used are explained in more detail below with the aid of drawings.

It show:

FIG. 1A: shows a first known braking system with its main components and its possible sources of error;

FIG. 1B: shows a second known braking system with its main components and its possible sources of error;

FIG. 2A: shows the design of a switching valve according to the invention with conventional coil and redundant double coil;

FIG. 2B-2D: show the operating principle of the modified switching valve with additional electromagnetic or permanent-magnet force generation device;

FIG. 3A: shows the first known brake system from FIG. 1 with tandem master brake cylinder THZ, pressure supply DV and control valves and with switching valves according to the invention instead of inlet valves with parallel check valves.

FIG. 3B: shows a third known brake system with tandem master cylinder THZ, pressure supply DV and control valves and with switching valves according to the invention instead of inlet valves with parallel check valves;

FIG. 3C: shows a fourth known system with tandem master cylinder THZ, pressure supply DV and control valves and with switching valves according to the invention instead of inlet valves with parallel check valves;

FIG. 3D: shows various valve circuits DV/TV next to SV2k for connecting the wheel brake cylinders to the pressure supply DV and the single master brake cylinder SHZ;

FIG. 4A: shows the second known brake system of FIG. 1B with single master brake cylinder SHZ, pressure supply DV and control valves and with switching valves SV2k according to the invention instead of inlet valves with parallel check valves;

FIG. 4B: shows various valve circuits DV/TV next to SV2k for connecting the wheel brake cylinders to the pressure supply DV and the single master brake cylinder SHZ;

FIG. 5A: shows various valve circuits 3/2 MV next to SV2k for connecting the wheel brake cylinders to the pressure supply DV and the single master brake cylinder SHZ;

FIG. 5B: shows a redundant pressure supply DV2 for brake circuit BK1 for the brake system according to FIG. 5A;

FIG. 5C: Shows two redundant pressure supplies DV2 and DV3 for brake circuit BK1 and brake circuit BK2 for the brake system according to FIG. 5A;

FIG. 5D: Shows a redundant pressure supply DV2 for brake circuit BK1 or brake circuit BK2 with changeover valve TV 3/2 for failure BK1 or BK2 for the brake system according to FIG. 5A;

FIG. 6: shows various valve circuits DV/TV next to SV2k for connection to the pressure supply DV and the single master cylinder SHZ;

FIG. 7: shows a time curve of the pedal force in the error case to produce an acceptable pedal feel;

FIG. 8: shows a further time curve of the pedal force in the error case for generating an acceptable pedal feel.

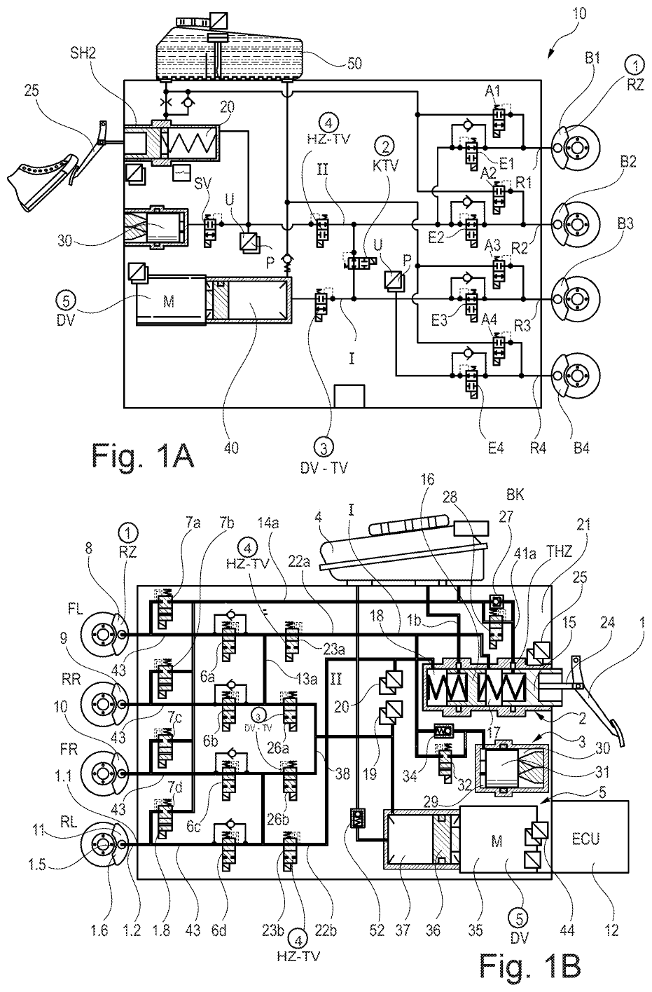

FIG. 1A and FIG. 1B—show the failure centers leading to circular failure in two different known systems. These are
1) The wheel brake cylinder RZ, the following component failures may contribute to its failure.
   1.1 Connection to the HCU hydro unit
   1.2 Brake line
   1.3 Brake hose connection to brake line (not marked in the FIGS.
   1.4 Brake hose
   1.4 Brake hose connection to brake caliper (not marked in the FIGS.
   1.5 Brake caliper
   1.6 Gasket wheel brake cylinder RZ
   1.7 Inlet valve check valve E1-E4
   1.8 Exhaust valve AV: The AV is a critical component for brake circuit failure in ABS, e.g. dirt particles in the valve seat can cause brake circuit failure with considerable loss of braking effect.
2) The KTV brake circuit separating valve
3) The valve DV/TV: Separating valve from the brake circuit to the pressure supply.
4) The valve HZ/TV: Separating valves from the brake circuit to the master cylinder HZ.
5) The pressure supply DV

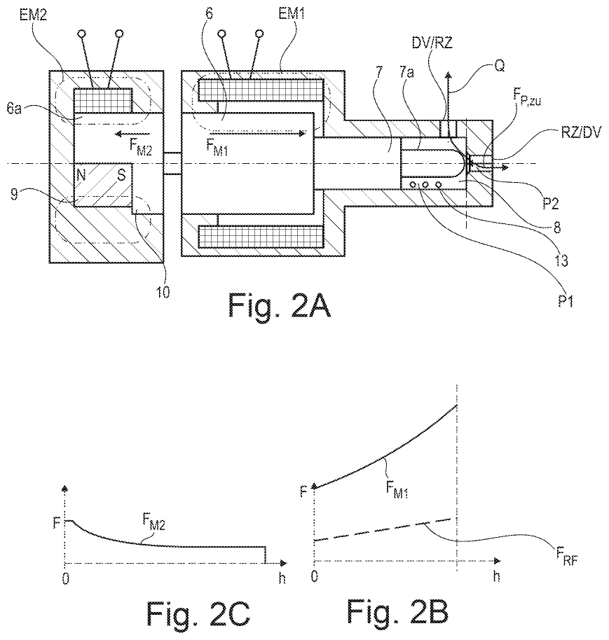

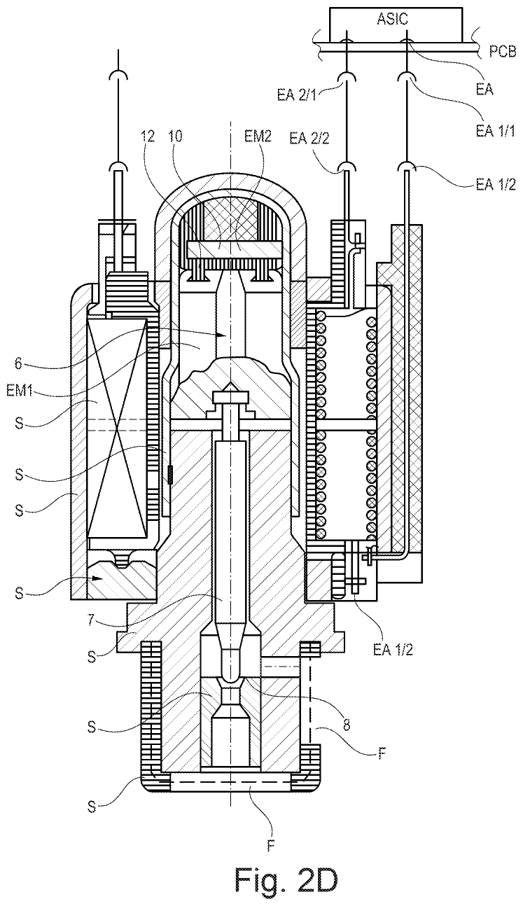

FIGS. 2A-2D shows the special switching valve SV2k required for the embodiments described above, which functions reliably in both flow directions, i.e. also at e.g. large flow rates, such as 100 cm³/s-120 cm³/s, and large pressure differences across the switching valve, such as e.g. 160 bar-220 bar. In particular, for the range described above, this valve SV2k ensures that it cannot close unintentionally by itself. The switching valve SV2k according to the invention has the typical structure of a solenoid valve with electromagnetic circuit EM1 with armature 6, valve actuator or valve stem 7 and valve seat 8 as well as the return spring 13 (see also FIG. 2B). The return spring 13 can be dispensed with if the additional force device, which in FIG. 2A is formed by the permanent-magnetic circuit EM2, is designed accordingly (see also FIGS. 2B-2D). The switching valve SV2k is shown on the left side conventionally with a single coil and on the right side with a redundant coil. The background is the analysis of the valve function “valve closing”. Here, essentially only the mechanical disturbance function “armature jammed” is to be considered, whereby the switching valve SV2k is protected against dirt particles by filter F at the inlet and outlet.

On the other hand, many influencing factors, such as electrical wire breakage, interference with the electrical connections EA (more than 4 connections) and with the ASIC, can occur. Since the SV2k switching valve is only relevant, for example, in the event of a double fault in the wheel circuit, a redundant design brings an enormous gain in safety, which is of great importance for Level 3 automated driving, e.g. system with electronic brake pedal.

This makes the SV2k switching valve double-fault-proof for various applications. To save installation space, the two coils have only 50% flow (i×n), so only both coils together can switch the maximum pressure load of >200 bar. I.e. in the normal case where the blocking limit is 100 bar, a single coil seems to be sufficient in the rare case of a fault. The valve actuator EM1 generates (see FIG. 2C) a strong progressive force FM1 over the armature stroke h and the return spring 13 for resetting the armature generates a progressive return force FRF over the stroke h. The armature 6 is then reset by the return spring 13. In the left part of FIG. 2B, the armature 6 is coupled to a second force-generating element which forms the additional force device according to the invention. This can consist of a second electromagnetic circuit EM2 with armature 6a, whose switchable force FM2 counteracts the force FM1 of the first magnetic circuit EM1. As a less expensive variant, a permanent-magnetic circuit can also be used as a passive additional force device, consisting of small permanent magnet 9 with pole plate 10. The force action of FM2 counteracts FM1 and acts with relatively strong force when the valve is open with a strong desired drop in force over the travel h. At the end of the stroke, the force FM2 is (see FIG. 2D) still large enough to take over the usual armature return, and can thus replace the usual return spring 13. At the valve seat, in the closed valve position, the pressure difference P2-P1 acts with the force FP, to which is directed in the direction of the valve opening, when the pressure P2 is greater than the pressure P1. In the open position of the valve, the hydraulic force FH described above acts on the valve seat due to the volume flow Q through the valve, which can close the valve without countermeasures, both during pressure build-up Pauf and pressure reduction Pab, depending on how the valve SV2k is connected to the pressure supply DV and the wheel brake cylinders RZ, and depending on the direction of the volume flow.

The hydraulic force on the valve armature FH, which acts when volume flow Q flows through the valve, acts in each case in the open position of the valve. Therefore, the force of the additional force device FM2 should act primarily in this position and, due to the decreasing force of FM2 over the armature movement in the direction of valve closing, it can thus be dimensioned higher in the open position than when using a spring with increasing force FRF during the armature movement in the direction of valve closing.

The valve tappet 7 may also have a special shape that provides the counterforce by hydraulic flow forces and can reduce the tightening force.

FIG. 2A shows the constructional design of the SV2k switching valve according to the invention based on a series inlet valve. The parts correspondingly present in the series part are all marked S. The check valve integrated in the series valve is omitted. Only four parts are additionally required for the power add-on device. These are
1. The permanent magnet 9
2. the pole plate 10
3. the electromagnetic inference 11 and
4. a plastic body 12, which connects the parts to each other including the anchor.

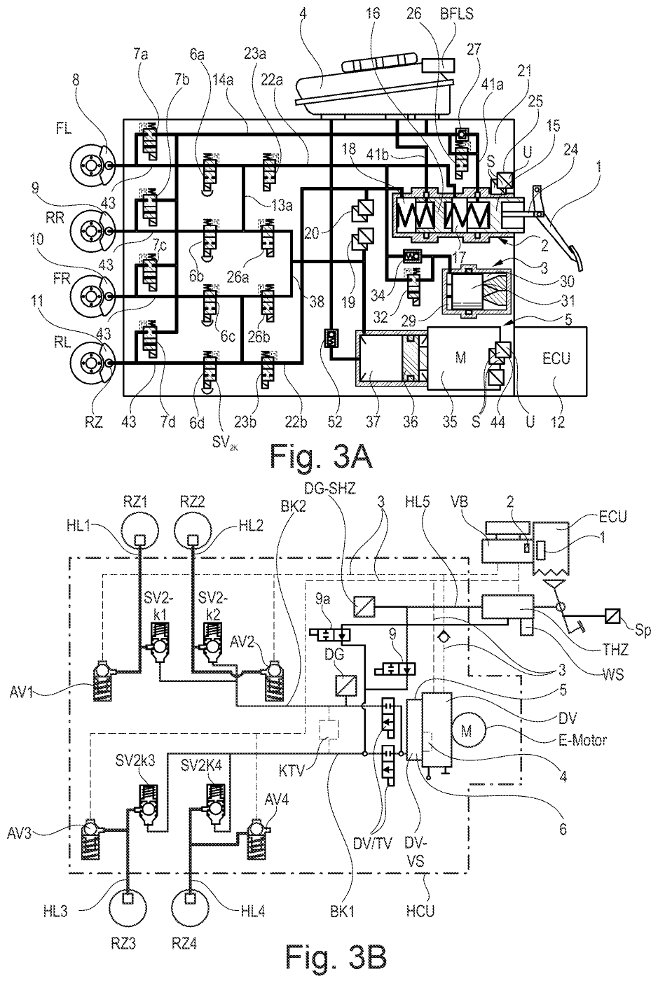

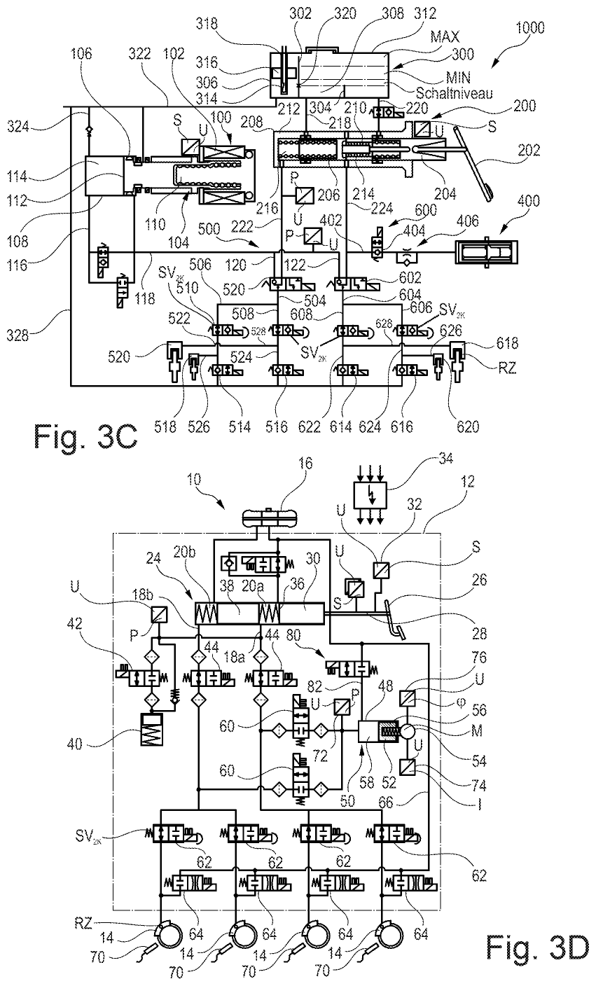

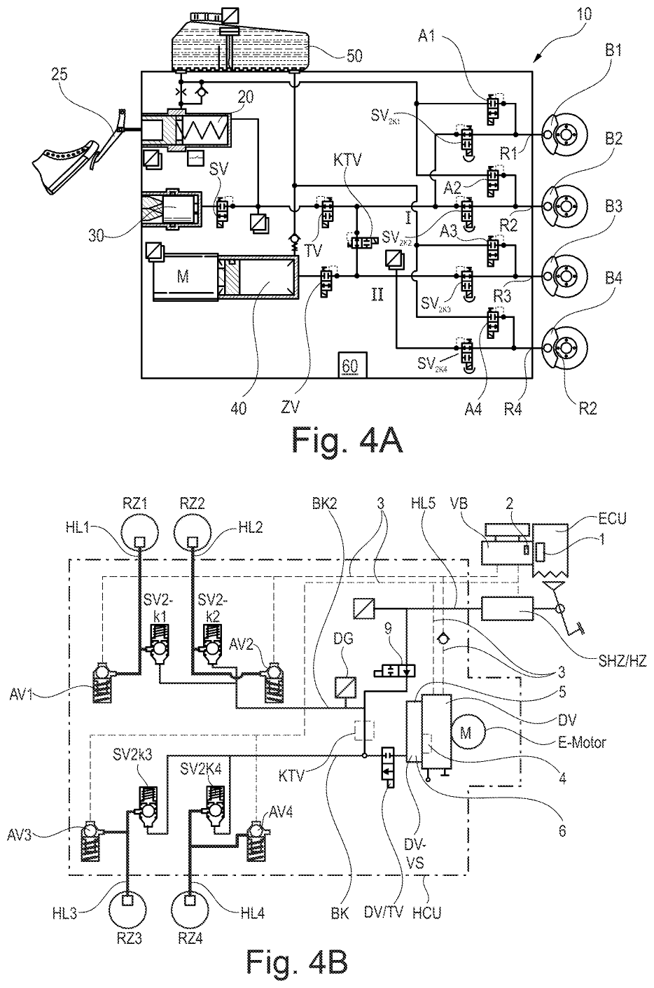

FIGS. 3A-3C and FIGS. 4A-4B show the two known systems of FIGS. 1A and 1B, respectively, and FIG. 3B and FIG. 3C show two further known systems with master cylinder HZ, pressure supply DV and control valves. Here, the known inlet valve is replaced by the switching valve SV2k. This allows the advantages described, e.g. in the event of failure of a wheel brake cylinder due to leakage and leakage of the associated exhaust valve AV, to be realized, possibly even with cost savings. Also in the case of ABS/ESP, where conceptually not all boundary conditions for the function and advantages can be realized. E.g. if a wheel brake cylinder RZ is leaking, then there can be no ABS function at the associated wheel, and ESP intervention at this wheel is then also not possible.

FIG. 3B corresponds to the patent application of FIG. 3A with master brake cylinder THZ, reservoir VB, pressure supply DV and solenoid valves MV 9 and 9a, master brake cylinder THZ, and solenoid valves DV/TV, pressure supply DV, and also the control valves AV1-AV4 and SV2k1-SV2k4 for ABS, whereby the associated valve SV2k can be closed in the event of failure of a wheel brake cylinder.

The two brake circuits BK1 and BK2 are connected to the wheel brake cylinders RZ1-RZ4 via hydraulic lines HL1-HL4. Likewise, the reservoir is connected to the wheel brake cylinders RZ1-RZ4 via hydraulic lines HL1-HL4. The two brake circuits BK1 and BK2 are connected to the DV via the isolating valves DV/TV, and to the master brake cylinder THZ via the hydraulic line HL5 and the solenoid valves 9 and 9a.

A diagnostic system detects a leak and, if a wheel brake cylinder, e.g. RZ1, leaks, it closes the connection from the wheel brake cylinder, e.g. RZ1, to the corresponding brake circuit, e.g. BK2, via the corresponding solenoid valve SV2k, e.g. SV2k1 (so-called single fault). If a double fault occurs, e.g. additional switching fault SV2k1, the DV/TV valve assigned to the BK, e.g. BK2, closes. The pressure supply DV is driven by an EC motor. The individual functions are described in great detail in the corresponding patent application of FIGS. 3A-3C and FIGS. 4A-4B.

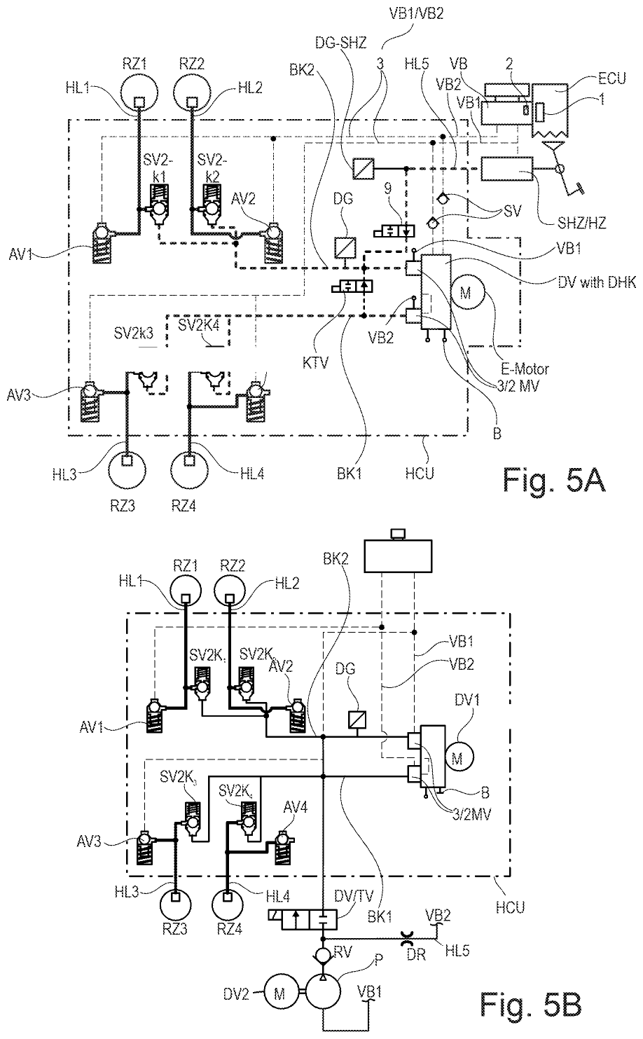

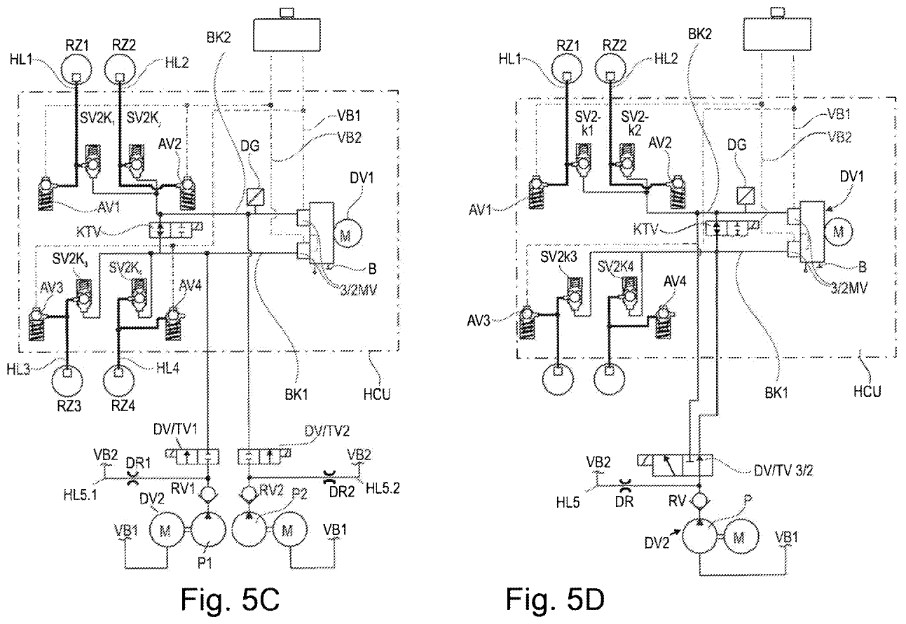

FIG. 3A shows the simplified structure of a brake system according to the invention with four wheel circuits with the hydraulic connections HL1-HL4 between the wheel brake cylinders RZ1-RZ4 and the valves SV2k1-SV2k4. Here, for example, wheel circuit 1 consists of wheel brake cylinder RZ1 and hydraulic line HL1. The exhaust valves can be provided optionally, and both one, two or even four exhaust valves can be provided. The hydraulic connections between the optional exhaust valves AV and the reservoir VB are shown as dashed lines. The valves SV2k have a hydraulic connection to the pressure supply DV via the brake circuits BK1 and BK2. As is known, piston pumps with so-called non-stepped single-stroke pistons and stepped pistons as double-stroke pistons with forward and return stroke are used as pressure supply DV. The pressure supply DV with single-stroke pistons has only one pressure outlet, while the pressure supply DV with double-stroke pistons has two pressure outlets, see FIG. 5A. A pressure supply DV with only one pressure outlet can be formed, for example, by a motor-driven piston-cylinder unit with only one pressure chamber or, for example, by a rotary pump. A pressure supply DV with two pressure outlets can be formed, for example, by a motor-driven double-stroke piston pump with two pressure chambers, in which case each pressure or working chamber is connected to or forms an outlet. The pressure supply DV with double-lift pistons is advantageously used for continuous conveying and also has advantages in the event of a fault in the four-circuit braking system for subsequent conveying to compensate for leaks. The DV pressure supply with double-stroke pistons requires a valve circuit for the outward and return stroke. Both piston types also optionally use the KTV circuit separating valve to separate the two brake circuits BK1 and BK2. In the four-circuit braking system with SV2k as the safety valve and in the safe n-circuit braking system, the KTV circuit isolating valve and the two-circuit feed from the DV pressure supply can again be dispensed with. With the advantages in the safety of the switching valve SV2k in the event of failure of a wheel circuit RK1, RK4, it is possible to dispense with the circuit isolating valve KTV if double fault safety is dispensed with, e.g. leakage from wheel brake cylinder 1 and leakage from valve SV2k1. The KTV circuit isolating valve is also not necessary when using redundant SV2k switching valves, or only in the case of extreme safety requirements.

If, on the other hand, a pressure supply with two outputs is used, see FIG. 5A, a brake circuit BK1 or BK2 is connected to each output of the pressure supply DV, whereby the circuit isolating valve KTV is then used for the optional connection or disconnection of the two brake circuits BK1 and BK2, as shown in FIG. 1A. The notes on the redundant valve SV2k also apply here. The pressure supply DV preferably has an EC motor with one or two phases and a corresponding number of winding controls, so that redundant operation is ensured. One or two pressure transducers DG can be provided to determine the ACTUAL pressure Pit, in the two brake circuits BK1, BK2. The master brake cylinder can optionally be designed as a single master brake cylinder SHZ or as a tandem master brake cylinder THZ, via which pressure can be generated in a brake circuit by means of the brake pedal if the pressure supply DV fails. The reservoir VB can be connected to or arranged on the master brake cylinder HZ, which has a float with a sensor target 2 arranged thereon, wherein a sensor element 1 is provided in the control and regulating unit ECU in order to detect the filling level of the reservoir. It is important to note the function of the diagnostic system.

All system concepts considered here are to be assigned to the brake by wire systems, BBW, which have a pedal travel simulator with separating valve coupled to the THZ or SHZ, and belong to the state of the art and are therefore not described.

It is also possible to equip non-BBW systems, e.g. ABS/ESP, by replacing the inlet valve EV with the valve SV2k with 4-circuit function with a corresponding increase in safety.

The different brake circuits are shown here in different states:
4-circuit in normal condition from valve SV2k and valve AV to wheel brake cylinder RZ with thick line (see FIG. 3B)
2-circuit at the double fault leakage wheel brake cylinder RZ and switching fault valve SV2k thick dashed from SV2k to the valves DV/TV and to the master brake cylinder THZ/SHZ (see FIG. 5A)

This also applies to FIGS. 4B, 5A, and 6 FIG. 4B corresponds to FIG. 3A with minor differences, reduction in the solenoid valve MV to the single HZ (SHZ) and to the pressure supply DV with only 1 isolating valve 9 or DV/TV each. The optional isolating valve KTV creates an additional upstream dual-circuit brake system with brake circuits BK1 and BK2 which, as already described, acts in the event of double faults, e.g. in the event of leakage of a wheel brake cylinder RZ and switching fault of the associated valve SV2k, with fallback levels as with the dual-circuit system (failure of brake circuit BK1 with failure of pressure supply DV or failure of brake circuit BK2).

FIGS. 5A-5D shows a DV pressure supply with DHK double-stroke pistons with 2×3/2 MV for perfect pressure control both in the forward and return stroke and extremely small overall volume. The KTV circuit separation valve is preferably used here for symmetrical volume control, since the 3/2 MV already effect circuit separation. The SV2k valves can also be used redundantly, e.g. with a redundant coil, in order to still achieve a safe braking effect in the event of the above-mentioned double fault of leakage of the wheel brake cylinder RZ+failure of the switching of the associated SVk valve. The facts about the redundant valve SV2k also apply here. This means that the KTV circular diverting valve is no longer necessary, since both connections can be connected to the DHK double-lift piston.

FIG. 5B, FIGS. 5C, and 5D show system 5 without master brake cylinder SHZ for SAE L3 with E-brake pedal, with redundant DV (DV1 and DV2).

FIG. 5B shows a 4-circuit brake system in which both outputs of the pressure supply DV1 are directly connected to each other. The redundant pressure supply DV2 is also directly connected to the two outputs of the pressure supply DV1 so that, for example, in the event of a failure of the pressure supply DV1, the pressure supply of the 4-circuit braking system can be ensured by the pressure supply DV2. In order to avoid a total failure of the brake in case of a double fault, i.e. leakage of the valve DV/TV and leakage of the pump P of the pressure supply DV2, a check valve RV is arranged between the valve DV/TV and the pump P of the pressure supply DV2. To diagnose the valve DV/TV for switching capability and leakage, the hydraulic connection between the check valve and the valve DV/TV is connected to the reservoir VB2 via the hydraulic line HL5, whereby an orifice DR is provided in this hydraulic line.

Normally, the legislator only requires safety for single faults for braking requirements. These systems with redundant DP are at least safe against double faults, and in some cases even against triple faults, for the faults considered here. This is achieved in FIG. 5B, for example, with the following double fault in the event of failure of a wheel brake cylinder RZ due to leakage (1st fault) and leakage of valve SV2k (2nd fault), and with triple fault in the event of failure of a wheel brake cylinder RZ due to leakage (1st fault), leakage of valve SV2k (2nd fault) and switching fault of the redundant (e.g. redundant coil) valve SV2k (3rd fault) with vehicle deceleration z=65%.

If the pressure supply DV1 fails, the pressure supply DV2 is switched on via valve DV/TV (single fault safety). In the case of pressure supply DV1 with ECE motor and 2×3-phase winding and low failure probability of the ECE motor, almost double fault safety of pressure supply DV1 can be achieved here.

FIG. 5C shows, as in FIG. 5B, a second pressure supply DV2, but with de-energized open valve KTV for separating the brake circuits BK1 and BK2 of the upstream 2-circuit brake system. In the event of the three failures leakage of wheel brake cylinder RZ, failure of coil 1 and failure of redundant coil 2 of the associated valve SV2k, switching of valve KTV can prevent both brake circuits BK1 and BK2 from failing. For example, in case of leakage of wheel brake cylinder RZ1 and failure of switching of valve SV2k1, brake circuit BK2 fails and valve KTV is then closed, with the second output of pressure supply DV1 maintaining brake pressure in brake circuit BK1. As an alternative to pressure supply DV1, e.g. in the event of failure of pressure supply DV1, the brake pressure in brake circuit BK1 can be maintained with pump P1 of pressure supply DV2 in this fault combination. Depending on the brake circuit distribution, the remaining vehicle deceleration z=30%-70%. Thus, safety is provided in the event of a triple fault. For the same reason as explained in FIG. 5B, the check valves RV1 and RV2, the hydraulic lines HL5.1 and HL5.2 and the throttle DR1 and DR2 are provided here at the pressure supply DV2.

In case of failure of the pressure supply DV1 (4th fault), the redundant pressure supply DV2 with two electric motors and two pumps is switched on. Cost-effective brush motors are sufficient here. Thus, safety is achieved with the DV2 in the event of a quadruple fault.

FIG. 5D shows, as in FIG. 5C, a second pressure supply DV2 with de-energized open circuit isolating valve KTV. In this concept, as in FIG. 5C, in the event of a triple fault, e.g. leakage of wheel brake cylinder RZ1 (1st fault), failure of coil 1 and coil 2 (2nd and 3rd faults) of valve SV2k1, the 3/2-way valve DV/TV should also switch over to the intact brake circuit BK1. For example, in the event of leakage of wheel brake cylinder RZ1 and failure of the switching of valve SV2k1, brake circuit BK2 fails and valve KTV is then closed, with the second output of pressure supply DV1 maintaining the brake pressure in brake circuit BK1. Alternatively to the pressure supply DV1, e.g. in case of failure of the pressure supply DV1, the brake pressure in brake circuit BK1 can be maintained with the pump P of the pressure supply DV2 in case of this fault combination. With triple fault safety, a failure probability in the range of approx. 10-18/year can be achieved with costs that can still be realized. In addition, with the low stress duration during the fault case and also pressure load, of approx. 100 bar, with rare failure both with the power, e.g. 70% and pressure range 70% and stress duration 20% considerable costs can be saved. In case of double failure leakage of check valve RV and leakage of pump P of pressure supply DV2, circuit isolating valve KTV is closed. Brake circuit BK1 fails, while the pressure in brake circuit BK2 is maintained via pressure supply DV1. Alternatively, in the event of this double fault, the KTV circuit isolating valve can be closed and the DV/TV valve switched. In this case, the brake circuit BK2 fails, whereby the pressure in the brake circuit BK1 is maintained via the pressure supply DV1.

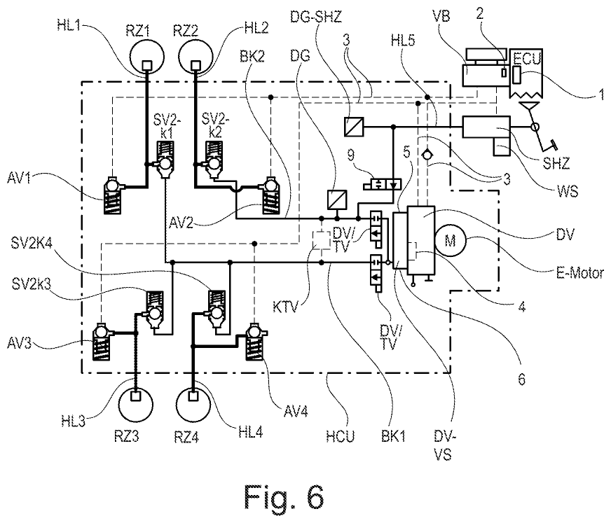

FIG. 6 shows a similar braking system to the system shown and described in FIG. 4B. In this system, the 2-circuit brake system is constructed with 1st circuit BK1 consisting of 3 RZ (RZ1, RZ3, RZ4) and the 2nd circuit BK2 with 1 RZ (RZ2). For this purpose, the optional circuit isolating valve KTV must be placed between brake circuit BK1 and valve SV2k2. The advantage is the greater vehicle deceleration z=65% in the event of double failure of wheel brake cylinder RZ2 (front wheel) due to leakage and failure of the control of valve SV2k2. The facts about the redundant SV2k also apply here.

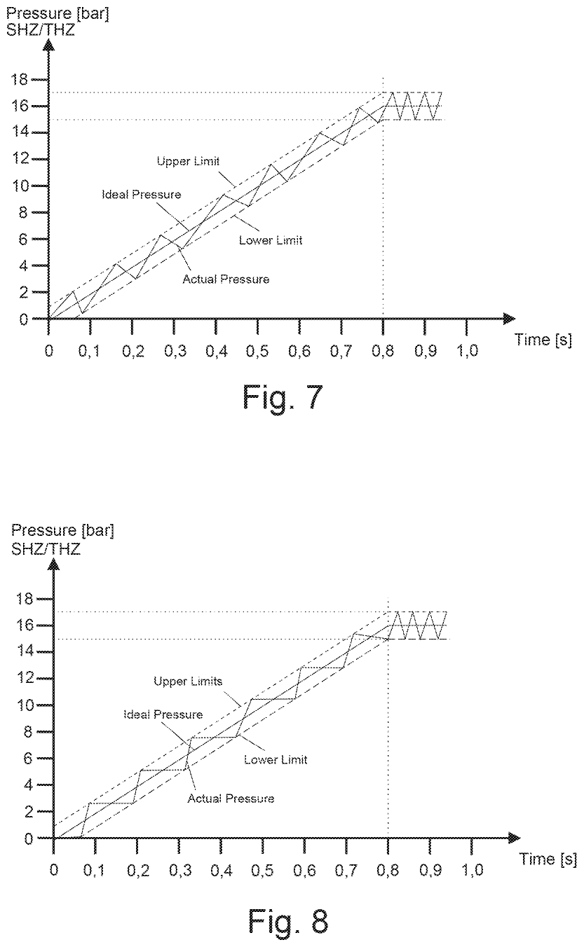

FIG. 7 shows the progression of the pedal force over time in the case of an error to generate an acceptable pedal feel.

The fault may be due to a leak in valve 9 (e.g. FIG. 4B). When the valve 9 is actuated, there may be a leak in the hydraulic connection between the master brake cylinder and the brake circuit BK2 due to penetrated dirt particles, for example. In this case, the brake system according to the invention can be used to form a fallback level in which the preservation of the brake pedal characteristic or pedal feel is generated by brake pedal force blending with the pressure supply DV.

Normally, when the driver applies the brakes, valve 9 is closed and the pressures in wheel brake cylinders RZ1-RZ4 are set to target pressures derived from the brake pedal travel using pressure supply DV. During braking by the driver (no recuperation, or the brake pressure in brake circuit BK2 is greater than the pressure in the master brake cylinder SHZ or THZ), brake fluid flows from brake circuit BK2 via the leaking valve 9 into the master brake cylinder SHZ or THZ as a result of the fault, pressing the brake pedal back, increasing the brake pedal force or the pressure in the master brake cylinder SHZ or THZ and reducing the brake pedal travel.

In an intact brake system, each brake pedal travel involves a defined pedal force or pressure in the master brake cylinder SHZ or THZ, which determines the pedal characteristic, and which is determined by the design of the travel simulator WS (see FIG. 3B). The pressure in the master cylinder is measured, e.g. directly with a pressure sensor DG-SHZ (see FIG. 3B), or indirectly with a force-displacement sensor (not shown) which can measure e.g. the pedal force. The brake pedal travel is measured with a pedal travel sensor Sp, which is shown in FIG. 3B. Thus, a target pressure in the master brake cylinder or target pedal force can be determined for each brake pedal travel. The design of the pedal characteristics is such that the pressure in the brake circuit is greater than the pressure in the master brake cylinder.

In the following, the process after detection of the fault is described as an example using a DG-SHZ pressure sensor, which can measure the pressure in the SHZ master brake cylinder. The fault is detected by permanently comparing the actual pressure in the master brake cylinder SHZ, which is measured by the pressure sensor DG-SHZ, with the target pressure in the master brake cylinder SHZ, which is determined on the basis of the pedal characteristics and the measured brake pedal travel. In the fallback level, when the difference between the actual pressure measured and the target pressure exceeds a selectable upper limit, e.g. 1 bar, the pressure supply DV is stopped, and the valves SV2k1-SV2k4 to the wheel brake cylinders RZ1-RZ4 are closed. The control of valve 9 is switched off and the pressure in the pressure supply DV is reduced via the control of the pressure supply

DV. As a result, brake fluid flows from the master brake cylinder SHZ, through the open connection from the master brake cylinder SHZ to the brake circuit BK2, into the brake circuit BK2 and through the valve DV/TV into the pressure supply DV. When the difference between the actual pressure and the set pressure in the master brake cylinder SHZ falls below a selectable lower limit value, e.g. −1 bar, valve 9 is activated again, the switching valves SV2k1-SV2k4 to the wheel cylinders RZ1-RZ4 are opened again and the pressures in the wheel cylinders RZ1-RZ4 are set to the set pressures again with the pressure supply DV. As a result of the error, the actual pressure in the SHZ master brake cylinder is increased again, as already described, and the brake pedal travel is reduced again. If the difference between the actual pressure and the set pressure in the master brake cylinder

SHZ again exceeds the selectable upper limit value, then the switching valves SV2k1-SV2k4 to the wheel cylinders RZ1-RZ4 are closed, valve 9 in the brake circuit is opened, and the pressure in the master brake cylinder SHZ is reduced via the pressure supply DV, thus repeating the process. As a result, brake pedal feel remains largely normal. However, slight brake pedal vibrations may occur.

FIG. 8 shows a further chronological progression of the pedal force in the event of a fault to produce an acceptable pedal feel. During this braking by the driver with recuperation, or the pressure in the brake circuit BK2 is less than the pressure in the master brake cylinder SHZ, brake fluid flows from the master brake cylinder SHZ into the brake circuit BK2 via the leaky valve 9 due to the fault, causing the brake pedal to move forward, reducing the brake pedal force or the brake pressure in the master brake cylinder SHZ and increasing the brake pedal travel.

The error is also detected here by permanent comparison of the actual pressure with the set pressure in the master brake cylinder SHZ. In the fallback level, if the difference between the actual pressure and the set pressure falls below the selectable lower limit value, the pressure supply DV is stopped and the valves SV2k1-SV2k4 to the wheel brake cylinders RZ1-RZ4 are closed. The control of valve 9 is switched off and the pressure in pressure supply DV is increased via the control of pressure supply DV. As a result, brake fluid flows from the pressure supply DV, through the valve DV/TV into the brake circuit BK2, and through the opened connection from the brake circuit BK2 into the master brake cylinder SHZ. When the difference between the actual pressure and the set pressure in the master brake cylinder SHZ exceeds the selectable upper limit value, the pressure supply is stopped, valve 9 is activated again, the switching valves SV2k1-SV2k4 to the wheel cylinders RZ1-RZ4 are opened again and the pressures in the wheel cylinders RZ1-RZ4 are set to set pressures again with the pressure supply DV. As a result of the error, the actual pressure in the SHZ master brake cylinder is reduced again, as already described, and the brake pedal travel is increased again. If the difference between the actual pressure and the set pressure in the master brake cylinder SHZ again falls below the selectable lower limit value, then the switching valves SV2k1-SV2k4 to the wheel cylinders RZ1-RZ4 are closed, valve 9 in the brake circuit is opened, and the pressure in the master brake cylinder SHZ is increased via the pressure supply DV, thus repeating the process. As a result, brake pedal feel remains largely normal. However, slight brake pedal vibrations may occur.

A leak in the SHZ master brake cylinder or in the WS travel simulator leads to a failure of the actuation unit (combination of SHZ master brake cylinder and WS travel simulator). When the driver applies the brakes, brake fluid flows out of the SHZ master cylinder through the leak in the actuation unit due to the fault, causing the brake pedal to move forward, reducing the brake pedal force or the brake pressure in the SHZ master cylinder and increasing the brake pedal travel. Therefore, the faulty operation of the actuation unit is similar to that described in FIG. 8. Thus, the detection of the fault and the fallback level as described in FIG. 8 can also be applied to these faults.

### LIST OF REFERENCE SIGNS

1 Sensor element
2 Target in float
3 Return line to VB with suction valve SV DV/TV DV specific valve circuit
5 single circuit pressure supply
6 Anchor 6/6a
7/7a Valve tappet
8 Valve seat
9/9a Separating valve for THZ/SHZ
B Bord net
B Board power supply redundant
RZ1-RZ4 wheel brake cylinder
BK1/BK2 Brake circuits
RK1 Wheel circuit 1
RK2 Wheel circuit 2
RK3 Wheel circuit 3
RK4 Wheel circuit 4
HCU Complete hydraulic unit with DV and valves
VB Reservoir
HL1-HL4 Hydraulic lines outside the HCU to the RZ
HL5 Hydraulic lines from SHZ to BV
KTV Circuit separating valve
DHK Double-stroke piston
DV Pressure supply
DG Pressure transducer
EA Electrical connection
EM1/2 electrical magnetic circuit 1/2
ElV Electric valve actuation
elEM Electric motor control of the electromechanical brake
MV Solenoid valve
RV Return valve
P/TV Pump Separator Valve
Sp Pedal travel sensor
TV isolating valve
P Pump
F Filter
9 Permanent magnet
Pole plate
11 Electromagnetic inference
12 Plastic body
13 Return spring
SV2k normally open solenoid valve without check valve in particular with a power add-on device

Overview of the electrical valve circuit
SO=de-energized open
SG=normally closed
AV=SG
SV=SO
Separating valve 9, 9a=SO
DV/TV (specific valve switching: SG, if necessary, with spring-assisted valve closing for
failure BK (can be omitted for SVv).
KTV=SO, possibly also SG for special application in FIG. 1A depending on requirements for residual braking effect in case of onboard power supply failure

1. A brake system including:
at least two wheel brake cylinders, which are each part of separate wheel circuits,
at least one pressure supply, which serves at least to build up pressure in the wheel brake cylinders,
at least one reservoir,
at least one electronic control and regulating device,
switching valves, wherein each wheel brake cylinder is connected via a respective hydraulic connecting line to a respective one of the switching valves, wherein the switching valves are arranged to hydraulically connect or disconnect the respective wheel brake cylinders and at least one hydraulic main line via which the switching valves are enabled to be connected to the at least one pressure supply, wherein the at least one hydraulic main line or the respective hydraulic connecting line and respective wheel brake cylinder connected to the respective hydraulic connecting line form part of a respective wheel circuit, wherein at least one of the following is true:
at least one of the switching valves includes at one redundant electric drive or one or more redundant components of an electric drive, or the at least one of the switching valves has a force-applying device with an associated magnetic field, by means of which the force-applying device exerts a force on a valve actuator or valve tappet or at least one of the switching valves has a return spring arranged to exert a force on the valve
actuator or valve tappet to prevent the at least one of the switching valves from tearing shut,
or
the brake system further includes at least one separating valve arranged to separate or connect at least two of the wheel circuits or at least two brake circuits.

2. (canceled)

3. The brake system according to claim 1, wherein, in a functional state in which at least one of the wheel circuits has a functional fault which is above a specific fault degree threshold, the pressure control:
disconnects the at least one of the wheel circuits with the functional fault at least temporarily
from the rest of the brake system or from the other wheel circuits or from the pressure supply,
or
separates or connects at least two of the wheel circuits or brake circuits from one another by means of the at least one separating valve.

4. The brake system according to claim 1, wherein at least one of the at least two brake circuits is assigned to at least two wheel circuits.

5. The brake system according to claim 1, wherein the electronic control and regulating device determines, based upon a diagnosis of leakage of one or more of the wheel circuits, whether one or more of the wheel circuits is switched off by closing a respective switching valve.

6. The brake system according to claim 1, wherein a respective one of the switching valves comprises a solenoid valve with an electromagnetic drive, via which a valve actuator or valve tappet is enabled to be adjusted between an open valve position and a closed valve position.

7. (canceled)

8. The brake system according to claim 1, wherein a force of the return spring is dimensioned such that it is greater than or equal to a sum of a frictional force and a tearing force.

9. (canceled)

10. The brake system according to claim 1, wherein the brake system has two pressure supplies, wherein, in a first functional state, a respective one of the two pressure supplies is assigned to a respective brake circuit to control pressure supply in the wheel circuits associated with the brake circuit, or wherein both pressure supplies are associated with both/all of the at least two brake circuits.

11. (canceled)

12. The brake system according to claim 10, wherein, in an event of a failure of a first one of the two pressure supplies the second one of the two pressure supplies takes over the function of the first pressure supply, in addition to its own function.

13. The brake system according to claim 1, further including a master brake cylinder arranged to be actuated via a brake pedal.

14. The brake system according to claim 13, wherein a pressure chamber or pressure chambers of the master brake cylinder is or are each connected to a brake circuit by means of a hydraulic line, with at least one isolating valve serving to selectively shut off the hydraulic line.

15. (canceled)

16. The brake system according to claim 1, wherein each respective one of the wheel brake cylinders is connected to a respective one of the switching valves via a respective hydraulic connecting line, wherein the respective one of the switching valves is used to connect and disconnect a hydraulic connection of the respective wheel brake cylinders to at least one further hydraulic main line via which the respective one of the switching valves is connected at least to the pressure supply, in which in each respective case, the respective hydraulic connecting line and the respective wheel brake cylinder are part of a respective one of the wheel circuits, wherein, as a function of a diagnosis of a degree of leakage in a respective one of the wheel circuits, the electronic control and regulating device is configured to control the respective switching valve of the respective one of the wheel circuits to switch off the respective one of the braking circuits or to permits the respective one of the braking circuits to continue to operate.

17. (canceled)

18. (canceled)

19. (canceled)

20. (canceled)

21. (canceled)

22. The brake system according to claim 1, wherein a respective one of the wheel circuits includes an exhaust valve associated with the respective wheel brake cylinder of the respective wheel circuit.

23. The brake system according to claim 1, wherein the force of the additional force device is generated by means of a current-carrying electromagnet and/or a permanent magnet.

24. The brake system according to claim 6, wherein the force of the force-applying device is opposed to a force of the electromagnetic drive.

25. (canceled)

26. (canceled)

27. (canceled)

28. The brake system according to claim 1, further including a level sensor arranged to determine a level of the reservoir.

29. The brake system according to claim 1, wherein the at least one pressure supply comprises an electric motor-driven piston-cylinder system.

30. The brake system according to claim 1, wherein the at least one pressure supply comprises an electric motor-driven rotary pump.

31. The brake system according to claim 1, wherein the at least one pressure supply comprises at least two pressure supplies, and wherein one of the at least two pressure supplies serves as a redundant pressure supply and serves as a backup in an event of failure of another one of the at least two pressure supplies and/or serves to support at least one other pressure supply of the at least two pressure supplies to generate pressures and/or to achieve brake system dynamics that are higher than would otherwise be possible.

32. The brake system according to claim 1, wherein the pressure supply comprises a first motor and a second motor, wherein the first motor is a brushless motor with 2×3 phases and redundant control and the second motor is a 1-phase motor.

33. The brake system according to claim 31, wherein at least one of the at least two pressure supplies is able to be separated from one or more of the brake circuits by means of a separating valve.

34. The brake system according to claim 33, wherein, in the case of two brake circuits, the separating valve is arranged to separate or connect the brake circuits.

35. (canceled)

36. (canceled)

37. The brake system according to claim 22, wherein, in an event of a faulty exhaust valve, pressure reduction and pressure build-up in an associated wheel circuit takes place via the switching valve of the respective wheel circuit.

38. The brake system according to claim 1, further including:
a master brake cylinder;
a travel simulator; and
a separating valve arranged to separate at least one of the brake circuits from the master brake cylinder,
wherein, in an event of leakage of the travel simulator, the master brake cylinder, or the separating valve, the pressure supply is controlled to control a pressure in the master brake cylinder to achieve a desired pedal characteristic or pedal force as a function of pedal travel using a pressure transmitter or a pedal force sensor.
